(19) United States
(12) Patent Application Publication
(10) Pub. No.: US 2025/0185648 A1
(43) Pub. Date: Jun. 12, 2025

(54) METHOD, DEVICE, AND CARDIOPLEGIC SOLUTION FOR THE PRESERVATION OF A DONOR HEART

(71) Applicants: Alexandre Ivachtchenko, Hallandale, FL (US); Andrey Ivashchenko, Hallandale, FL (US); Nikolay Filippovich Savchuk, Rancho Santa Fe, CA (US); Valentin Volgushev, Hallandale, FL (US); Nikolai Merkin, Hallandale, FL (US)

(72) Inventors: Alexandre Ivachtchenko, Hallandale, FL (US); Andrey Ivashchenko, Hallandale, FL (US); Nikolay Filippovich Savchuk, Rancho Santa Fe, CA (US); Valentin Volgushev, Hallandale, FL (US); Nikolai Merkin, Hallandale, FL (US)

(21) Appl. No.: 18/534,476

(22) Filed: Dec. 8, 2023

(51) Int. Cl. A01N 1/02

(52) U.S. Cl. CPC A01N 1/143; A01N 1/126; A01N 1/148

(57) ABSTRACT

A method of preserving a donor heart, comprising perfusing the donor heart with oxygenated blood-based perfusate, wherein the donor heart is predominantly kept in non-beating state.

### FIELD OF THE INVENTION

The present invention generally relates to medicine, and in particular to the preservation of a donor heart in a non-beating state while perfusing it with oxygenated blood-based perfusate at normal temperature in transplantology.

### BACKGROUND AND SUMMARY

Currently, hypothermic techniques are mainly used to preserve a donor heart, which techniques involve placing the heart in a tank with a preservative solution at a temperature of about 2-4° C. This approach preserves the viability of the heart for 3-4 hours. An example of a preservative solution used is Custodiol® (histidine-tryptophan-ketoglutarate).

Transmedics company has developed a mobile perfusion apparatus to preserve and transport a donor heart. The essence of the concept is that the heart must not “notice” the change of the host. During the entire preservation period, the heart is maintained under near-physiologic conditions and functions in a human-like, metabolically active state (see, e.g., U.S. Pat. No. 6,100,082 Aug. 8, 2000], U.S. Pat. Nos. 7,651,835, 8,409,846). This approach assumes that the heart beats for the entire period of maintenance. The beating organ is perfused with oxygenated blood-based perfusate at a temperature of 20-37° C. The perfusate contains saline solution, heparin, antibacterial agents, nutrition (glucose and fatty acids), and cardiotonics (to stimulate heart contractions). The device enables two operation modes: preservation mode, during which the heart is maintained with retrograde perfusion and the system pumps the perfusion fluid at a rate of 300 ml/min to 1000 ml/min, and contractility test mode, during which the heart is maintained with antegrade perfusion and the system pumps perfusion fluid to the heart at a rate of between 1 liter/min to 5 liters/min prior to transplantation to test the contractility of the preserved heart. Drainage is installed in its cavity to evacuate the blood entering the left ventricle during contractions. This method permits an increase in the preservation period of the donor heart compared to the hypothermic method. During investigation of this approach as part of a clinical study, the median perfusion duration in patients was 6.35 hours, with a donor heart survival rate of 81% (75 out of 93 hearts) (see Shroder et. al//Successful Utilization of Extended Criteria Donor (ECD) Hearts for Transplantation-Results of the OCS™ Heart EXPAND Trial to Evaluate the Effectiveness and Safety of the OCS Heart System to Preserve and Assess ECD Hearts for Transplantation//Journal of Heart and Lung Transplantation, Volume 38, ISSUE 4, SUPPLEMENT, S42, April 2019 DOI: 10.1016/j.healun.2019.01.088). As is evident, further innovation is still needed to improve perfusion duration and survival rate.

This application presents innovative methods and devices for the long-term preservation of a donor heart by perfusing it with oxygenated blood-based perfusate at normal temperature, preferably maintaining the heart in a non-beating state to virtually exclude intracardiac hemodynamics and to avoid the consequences of deviations in mechanisms of regulation of an isolated beating heart.

Further objects, features, and advantages of the present invention will become apparent from the detailed description of preferred embodiments, which is set forth below when considered together with the figures of drawing.

### BRIEF DESCRIPTION OF THE DRAWINGS

FIG. 1. depicts an example of hemodynamic flow while maintaining a non-beating heart. The diagram visualizes the hemodynamic flow at the organ maintenance and preservation stage according to the invention. Oxygenated perfusate is fed into the aorta and enters the mouths of coronary arteries; oxygen-depleted perfusate then leaves coronary vessels through the coronary sinus, right atrium, and right ventricle and is finally taken into the perfusion system through the pulmonary artery for repeated oxygenation.

FIG. 2. depicts a schematic diagram of a heart preservation device. The diagram depicts an embodiment of certain elements of the device, the order of their connection, and the direction of movement of the perfusate during perfusion of the preserved donor heart. The device shown herein can provide all required perfusion parameters as described herein.

FIGS. 3A and 3B. depicts an example of the level of potassium K+ ions in perfusate (mmol/L). In this embodiment, the level of K⁺ in perfusate in 11 out of 16 experiments was kept at a level of more than 9 mmol/L for the entire perfusion period. As shown in experiments 1, 3, 4, and 12 to 16, K+ levels were decreased to less than 9 mmol/L at the end of the preservation period, which was associated with appropriate measures taken to test the restoration of the contractility of the heart at the end of preservation stage. In experiments 1, 4, and 12, the K⁺ level was 6 to 9 mmol/L at the beginning of the perfusion stage and was increased to a level exceeding 9 mmol/L. In experiment 3, the K⁺ level was 7.3 mmol/L at the beginning of the perfusion stage and was increased to values exceeding 9 mmol/L, at which it was kept until the end of the maintenance stage, with subsequent decrease in order to check the contractility of the organ. In experiment 6, the initial K⁺ level exceeded 9 mmol/l, and after 10 hours of preservation, it gradually decreased to 7.3 mmol/L, after which it was increased to the required level exceeding 9 mmol/L.

FIG. 4. depicts the volume of potassium cardioplegic solution (in ml) injected into the perfusate to maintain the heart in a predominantly non-beating state according to one embodiment of this application. In this embodiment, the conditional norm of cardioplegic solution, necessary and sufficient to maintain a preserved heart in a non-beating state, is 0.40 mL/mg with tolerable deviations up to 1.5 times in each direction. In the conducted experiments, the indicator varies from 0.21 ml/g to 0.62 ml/g.

FIG. 5. depicts an example of heart rate during the preservation stage. The total number of heart contractions during the preservation period varied from zero (experiment 2) to 20% of the norm (experiment 7). The norm is calculated as the number of 70 heart contractions per minute multiplied by the duration of the heart preservation period in minutes.

FIG. 6. depicts an example of ACT levels in the perfusate during the preservation stage. In a set of experiments, additional heparin administration was performed in 10 out of 16 experiments. Heparin was added during the first two hours since the aorta was cross-clamped in the donor's body only if ACT (activated clotting time) was less than 400 seconds. The dose of heparin varied from 0.5 ml to 3 ml. A single case of a second additional injection of 2 ml of heparin was recorded in experiment 12 due to blood-based perfusate leakage from the perfusion system.

FIG. 7. depicts an example of bicarbonate injections during the preservation stage. It is clearly demonstrated that acidosis was not recorded, and NaHCO₃ injection was not required in experiments with a stable time-dependent trend of lactate levels (experiments 2 and from 12 to 16).

FIG. 8. depicts an example of lactate level values during the preservation stage in mmol/L. The lactate level depends on the quality of perfusate oxygenation. In experiments from 1 to 11, technical difficulties negatively influenced the quality of oxygenation, so weighted average values of lactate varied from 7.15 mmol/L to 11.25 mmol/l. Experiments 12 to 16 were performed with acceptable quality of perfusate oxygenation, so weighted average values of lactate level during the period when lactate levels were stable are significantly lower and lie in a range from 2.5 mmol/L to 4.6 mmol/L. As a result, every heart was successfully preserved during experiments from 12 to 16, while in a subset of the first 11 experiments, only 5 hearts were preserved successfully.

FIGS. 9A and 9B. depicts time trends of lactate during the preservation stage in experiments 1-16. In experiments from 1 to 11, technical obstacles negatively influenced the quality of oxygenation; as a result, an upward trend of lactate over time was recorded in almost all of these experiments (both successful and unsuccessful from the point of view of organ preservation), and lactate weighted average values varied from 7.15 mmol/L to 11.25 mmol/L. Experiments from 12 to 16 were performed with acceptable quality of perfusate oxygenation, so weighted average values of lactate level during the period when lactate levels were stable are significantly lower and lie in a range from 2.5 mmol/L to 4.6 mmol/L. The upward trend at the end of the preservation stage in experiments 14, 15, and 16 is due to a scheduled perfusion pause performed twice in each experiment: the first lasted 10 minutes, and the second lasted 30 minutes. All experiments from 12 to 16 were completed successfully, i.e., the organ was preserved and resumed its normal contractility. The trend column shows the lactate values (on the vertical axis), and the preservation time (on the horizontal axis); each vertical grid line indicates 1 hour of preservation. The horizontal dotted line indicates a 2 mmol/L lactate level value.

FIG. 10. depicts an example of glucose injections during the preservation stage. Experiments 2 and 12 to 16 are characterized by a relatively stable time trend of lactate levels. In these experiments, glucose was consumed sparingly and required its administration a minimum number of times (once or twice), and no additional glucose injections were required in experiments 15 and 16. On the contrary, in the rest of the experiments, an upward trend of lactate was recorded, and one can see an active consumption of glucose depicted by a significant reduction in glucose concentration over time. Glucose administration was required three to five times in experiments 1 and 3 to 11.

FIG. 11. depicts an example of perfusate pressure during the preservation stage. The ratio of the weighted average perfusion pressure to the mass of the organ according to a series of experiments 1 to 16 varies from 0.17 mmHg/g to 0.69 mmHg, with a conditional norm of a diastolic value of 0.35 mmHg/g and deviation up to two times in both directions. In general, the perfusion pressure during the experiments was maintained closer to the level of normal diastolic pressure, taking into account the mass of the preserved organ—in the group of experiments from 1 to 11, the hearts had relatively low mass, and weighted average pressure value was slightly less than 100 mmHg. In the subset of experiments 12 to 16, with a relatively high organ mass, the weighted average pressure was closer to 120 mmHg.

FIG. 12. depicts an example of the volumetric perfusion rate during the preservation stage. The weighted average volume perfusion rate in a subset of experiments with an upward lactate trend (experiments 4-7, 9-11) ranged from 0.62 ml/min/g to 1.20 ml/min/g. The same range in a subset of experiments with a stable lactate trend (experiments 8, 12-16) ranged from 0.38 ml/min/g to 0.58 ml/min/g. The conditional norm of coronary blood flow in a steady state is considered to be around 0.60 ml/min/g. The volumetric perfusion rate was sometimes twice lower than the conditional norm in experiments with a stable lactate trend and a high organ mass. In comparison, in experiments with an upward lactate trend, these values exceeded the conditional norm up to two times.

FIG. 13. depicts data from preserved pig hearts and the results of histological and microtomographic examinations. The histological and microtomographic examination data of five successfully preserved pig hearts indicate the high quality of donor organs preserved according to the invention in the range from 16 to 21 hours. In the heart harvested after experiment 8, histological examination revealed that initial signs of myocardial infarction emerged in individual fragments, which was associated with the technical difficulties of oxygenation.

### TERMS AND DEFINITIONS

A list of terms used in the present disclosure is provided below. The terms “includes,” “comprises,” “contains,” as well as “including,” “comprising,” and “containing” in the disclosure should be interpreted as open-ended, for example, “including but not limited to.” These terms are not intended to be interpreted closed-ended, for example, “consists only of.”

A cardioplegic solution is a solution that includes cardioplegic agents and other components in the amount necessary to arrest and maintain the donor heart in a non-beating state.

A perfusion is the flow of perfusate through the coronary vascular network of a preserved donor heart in order to maintain it in a viable state. Perfusion is performed with a perfusion pump.

Blood perfusate (or perfusate) is a blood solution with added medicinal agents and/or electrolytes and/or nutrients used to perfuse a preserved donor heart.

Oxygenated perfusate is a perfusate saturated with oxygen in a physiological volume using an oxygenator.

Perfusion parameters-include, but are not limited to, the volumetric perfusion rate in milliliters per minute, the level of oxygenation of perfusate delivered to the coronary bed in percents, perfusion pressure in mmHg, perfusion temperature in degrees Centigrade.

A perfusion circuit is a closed system designed for the perfusion of a preserved donor heart that includes a container for organ storage, a container with perfusate, an oxygenator, a pump, a heat exchanger, and tube lines that connect all elements into a whole perfusion system that provides organ perfusion with oxygenated perfusion at a required temperature.

Perfusion pressure is the pressure created by the perfusion pump in the perfusion circuit. If the perfusion pump (for example, roller pump or peristaltic pump) creates the pulsatile flow of the perfusate, the upper pressure indicated on the pressure monitor is taken as the perfusion pressure. During the perfusion of a donor heart, the pressure in the perfusion circuit is monitored by a blood pressure sensor, in particular, a standard sensor used in cardiac surgery.

Predominantly non-beating state of the heart means that the heart does not beat or beats periodically or beats in bradycardia mode during the preservation stage, and the total number of full-fledged contractions during the entire preservation period must not exceed one-third of the normal number of contractions for the same period, while said normal number of contractions is calculated based on the conditional physiological norm of 70 contractions per minute, multiplied by the duration of preservation period expressed in minutes.

Unless specified otherwise, technical and scientific terms in this application have standard meanings common in science and technical literature.

### DETAILED DESCRIPTION OF THE INVENTION

A first aspect of the invention is a method for preserving a donor heart that includes perfusion of the heart with oxygenated blood perfusate, while the preserved heart is predominantly maintained in a non-beating state.

A distinctive feature of this method is the perfusion of the donor heart, while the heart stays predominantly in a non-beating state during the preservation stage.

In accordance with embodiments of the present invention, a donor heart shall be arrested with the help of potassium cardioplegia and then delivered to be preserved in a predominantly non-beating state.

In accordance with embodiments of the present invention, the preserved donor heart is perfused at a temperature of 20-37° C.

In accordance with embodiments of the present invention, the blood of the donor is used as the basis of the perfusate.

In accordance with embodiments of the present invention, at the stage of heart preservation, oxygenated perfusate is fed into the aorta and enters the mouths of coronary arteries. Subsequently, oxygen-depleted perfusate leaves coronary vessels through the coronary sinus, right atrium, and right ventricle and is finally taken into the perfusion system through the superior vena cava or pulmonary artery for repeated oxygenation.

In accordance with embodiments of the present invention, the heart is maintained in a non-beating state by creating and maintaining an increased content of potassium ions in perfusate up to 9 mmol/L or more during the stage of preservation.

In accordance with embodiments of the present invention, if the heart starts to contract normally or in the mode of bradycardia during the stage of preservation, then an additional amount of potassium ions is added into the perfusate in order to transfer the heart to a non-beating state again.

In accordance with embodiments of the present invention, the heart does not beat or beats periodically or beats in bradycardia mode during the preservation stage, and the total number of full-fledged contractions during the entire preservation period must not exceed one-third of the normal number of contractions for the same period, while said normal number of contractions is calculated based on the conditional physiological norm of 70 contractions per minute, multiplied by the duration of preservation period expressed in minutes.

In accordance with embodiments of the present invention, blood clotting ability is monitored during the stage of organ preservation and if the values of Activated Clotting Time (ACT) are less than 400 seconds, which is typical for cardiac surgery procedures under conditions of extracorporeal blood circulation, ACT is adjusted by adding heparin or another pharmaceutically acceptable anticoagulant into perfusate.

In accordance with embodiments of the present invention, a stable or downward time trend of the lactate level is maintained during the stage of organ preservation.

In accordance with embodiments of the present invention, during the stage of organ preservation, the glucose concentration in the perfusate is controlled to stay in the range of values close to normal.

In accordance with embodiments of the present invention, during the stage of organ preservation, the acid-base state, gas, and biochemical composition of the perfusate must be maintained in the range of values close to normal both inside arterial and venous lines by the methods that are typical for cardiac surgery.

In accordance with embodiments of the present invention, the perfusion pressure divided by the heart weight is maintained close to the conditional normal value of 0.35 mmHg/g with deviations up to two times in both directions.

In accordance with embodiments of the present invention, the volumetric perfusion rate is maintained close to the conditional normal value of 0.6 ml/min/g with deviations up to two times in both directions.

In embodiments of the present invention, to check the preservation quality by measuring the contractility of the heart, after the preservation stage immediately before transplantation, the concentration of potassium in the perfusate is decreased to normal values, the heart starts to beat, and oxygenated perfusate is pumped at a volumetric rate of up to 5 liters per minute through the pulmonary vein, into the left atrium and through the mitral valve into the left ventricle, then during systole into the aorta, during diastole into the mouths of the coronary arteries, after which oxygen-depleted perfusate leaves the coronary sinus, into the right atrium, then into the right ventricle, from where it is finally taken into the perfusion system for repeated oxygenation. This method of testing the contractility of the heart is possible but optional.

A second aspect of the invention is a device for preserving a donor heart in the manner described above, which includes a container to store an organ, a container with perfusate, an oxygenator, a pump, a heat exchanger, and tube lines that connect all the elements into a single perfusion system that provides perfusion of the organ with oxygenated.

A distinctive feature of this device is implementing an innovative method of preserving a donor heart, which is predominantly maintained in a non-beating state.

In accordance with embodiments of the present invention, the device contains a unit to display the perfusion volume rate, perfusate pressure, heart rate, acid-base state, gas, and biochemical compositions of the perfusate inside arterial and venous lines.

In accordance with embodiments of the present invention, the device contains a component that permits control of perfusion volume rate, perfusate pressure, heart rate, acid-base state, gas, and biochemical compositions of the perfusate inside arterial and venous lines, and a unit that configured to inject electrolytes and medicines into the perfusate in order to bring the perfusate parameters to the required range if it is medically necessary and to maintain said parameters in the range of values close to normal both inside arterial and venous lines.

A third aspect of the invention is a cardioplegic solution utilized to preserve a donor heart according to embodiments of the methods described herein. Thus, provided herein is a solution containing pharmaceutically acceptable potassium ions in an amount necessary to stop the donor's heart and to maintain it in a non-beating state; said solution additionally containing at least one component selected from the group consisting of magnesium ions, diuretic, base, acid, and distilled water.

In one embodiment, a distinctive feature of this cardioplegic solution is the implementation of an innovative method for preserving a donor heart, which is predominantly maintained in a non-beating state.

In accordance with embodiments of the present invention, a cardioplegic solution is an aqueous solution containing:
Potassium chloride 3-15 g;
A buffer system with a concentration of hydrogen ions H⁺, providing a pH of the solution in the range of 7.1-8.9;
Distilled water—up to 1000 ml;
In accordance with embodiments of the present invention, a cardioplegic solution is an aqueous solution containing:

Potassium chloride 3-15 g;
Magnesium sulfate 0-2.93 g;
A buffer system with a concentration of hydrogen ions H⁺, providing a pH of the solution in the range of 7.1-8.9;
Distilled water, ml-up to 1000.

In accordance with embodiments of the present invention, a cardioplegic solution is an aqueous solution containing:
Potassium chloride 3-15 g;
Magnesium sulfate 0-2.93 g;
A pharmaceutically acceptable diuretic providing osmolarity in the range of 275-460 mOsm/kg;
A buffer system with a concentration of hydrogen ions H+, providing a pH of the solution in the range of 7.1-8.9;
Distilled water, up to 1000 ml.

In accordance with embodiments of the present invention, the cardioplegic solution is characterized by the fact that it is derived from the following components:
Potassium chloride—7.45 g;
Magnesium sulfate—2.34 g;
Trometamol—0.5 g;
Mannitol—35.9 g;
Distilled water up to 1000 ml, subject to the introduction of 1M hydrochloric acid until the pH is 7.6-8.0.

Embodiments of the invention solve the problem of long-term preservation of the donor heart by creating a natural blood supply, eliminating the development of ischemia, reperfusion injuries, and overstretching of the heart chambers. The invention virtually eliminates cardiac hemodynamics of the normally contracting heart while providing adequate coronary blood flow, which feeds the heart muscle.

The specified technical result is achieved by perfusing the donor heart with oxygen-enriched perfusate, maintaining the heart predominantly in a non-beating state, and supplying the heart with blood-based perfusate through coronary vessels, bringing the preservation conditions closer to natural physiological conditions. At the same time, the donor's own blood is used as the basis of perfusate. Perfusate infusion may be performed either into the mouths of the coronary arteries using specialized cannulas or into the coronary vessels from the cavities of the heart.

Keeping a donor organ predominantly in a non-beating state allows one to avoid the consequences that are typical for violation of mechanisms regulating the state of the beating heart. In particular, violation of the barotropic mechanisms of regulating the beating heart leads to asynchronous operation of the heart valves and violation of intracardiac hemodynamics. Violation of chronotropic mechanisms of regulation of the beating heart leads to overstretching of the chambers of the heart and requires drainage of the left ventricle to evacuate excess stagnant perfusate from the cavity of the left ventricle.

Embodiments of the invention may be implemented in the following sequence. The heart in the donor's body is stopped using any of the generally accepted cardioplegic techniques, after which it is taken according to the generally accepted method and placed in a device where it is stored according to embodiments of the present invention. In the studies that relate to the present invention, potassium normothermic techniques were used to stop the heart inside the donor's body. In particular, a potassium cardioplegic solution was compiled according to embodiments described herein, and the Calafiori method was also used in experiments on rat hearts.

The perfusate temperature was maintained between 28-37° C. during the organ preservation stage in most experiments on pig hearts and between 20-30° C. in the subset of experiments on rat hearts. The acceptable temperature range of perfusate during the preservation period is 20-37° C. This temperature range is one in which the blood, which is the basis of perfusate, performs all its basic functions, i.e., at least those related to the supply of the organ with nourishment and respiration.

Embodiments of the invention are also described in a set of in-vivo and in-vitro experiments. In particular, experiments were carried out on rat hearts using the Langendorff apparatus, while experiments on porcine hearts were performed in cardiac surgery operating rooms equipped in accordance with the requirements for conventional medical cardiac surgery operating rooms. The most illustrative were the 16 experiments on porcine hearts, on which further presentation of embodiments of the invention is based. The first 11 of these 16 experiments were carried out on minipigs weighing 27-38 kg, and the next experiments from 12 to 16 were performed on pigs weighing 80 to 133 kg.

Combined endotracheal anesthesia was performed, followed by left-sided lateral thoracotomy, with resection of the fourth rib. A cardioplegic cannula was inserted into the aortic root, and blood was collected and reserved for subsequent perfusion during the stage of preservation, followed by perfusate replacement at the stage of simulations of organ transplantation and restoring its functionality in the recipient's body. In experiments 1 to 11 (in animals with low mass), 1,000 to 1,500 ml of blood was collected, while in experiments 12 to 16 (in animals with higher body mass), about 3,000 ml of blood was collected.

A potassium normothermic cardioplegic agent according to embodiments described herein was used for cardiac arrest. The stopped heart was explanted and placed into a specific storage container in which the required range of temperature and humidity were provided. The heart was connected to the perfusion system, which included an oxygenator, a rotameter, a temperature-regulating device, roller pumps, and a system of blood-conducting tube lines. Also, infusion devices were used to inject medicinal agents into the perfusate in most experiments. Monitoring was carried out with pressure sensors, temperature sensors, and a patient's monitor (STORM 5500). Different oxygenators were used, in particular Maquet Quadrox-I Pediatric, SORIN (Livanova) Kids, SORIN (Livanova), DIDECO Kids D100, Terumo Capiox FX-25. The activity of atriums alone was ignored during experiments. If the contractile activity of the heart was manifested during perfusion, a cardioplegic solution, according to the present invention, was added to the perfusate. During the stage of preservation of the heart, perfusate was collected, and its parameters were analyzed, including saturation of gases, parameters of acid-base state, concentration of electrolytes, and the presence and concentration of metabolic products. The examples below illustrate but do not limit this invention.

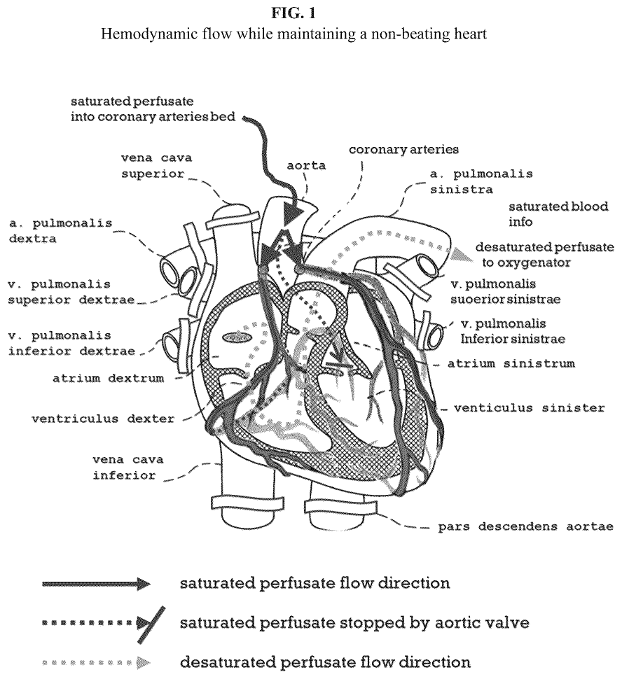

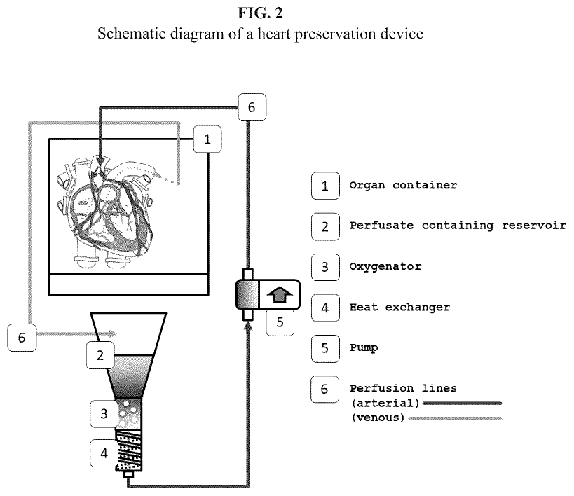

The ascending aorta is hermetically fixed to the arterial line of the device, which allows perfusate to be injected directly into the aorta, from where it flows into the coronary arteries (FIG. 1 and FIG. 2). The perfusate leaves the coronary vessels and enters the cavity of the right atrium and right ventricle, from there it is taken through the superior vena cava or pulmonary artery. In some cases, a catheter may be installed into the coronary sinus to collect flowing perfusate. The outgoing perfusate enters the tube line, which is hermetically fixed to the venous line of the equipment. Perfusate subsequently flows through the oxygenator and heat exchanger and is repeatedly directed to the mouths of the coronary arteries. If necessary, a catheter is installed and fixed in the lower pulmonary vein on the left (v. pulmonalis inferior sinistra) to drain the left ventricle to prevent the accumulation of perfusate in the cavity of the stopped heart.

Arterial and venous perfusate is monitored periodically or in real-time during the process of preservation. The following parameters are tested: acid-base state parameters, concentrations of gases, concentration of electrolytes and metabolic products, including, but not limited to: pH, Base Excess BE in mmol/L, bicarbonates HCO₃ in mmol/L, partial pressure of carbon dioxide pCO2 in mmHg, partial pressure of oxygen pO2 in mmHg, saturation of SO₂ in %, K⁺ in mmol/L, Na⁺ in mmol/L, Ca⁺⁺ in mmol/L, hemoglobin Hb in g/dl, hematocrit Hct in % of PCV (Packed Cell Volume), Activated Clotting Time ACT in seconds, lactate concentration Lac in mmol/L, and glucose concentration Glu in mg/dL. The following parameters are also monitored, including, but not limited to: heart rate in beats per minute, volumetric perfusion rate V in ml per minute, perfusion pressure P in mmHg, and perfusate temperature T in ° C.

All parameters, except potassium ions K⁺ concentration and AST (Activated Clotting Time), are maintained within normal range by the ordinary measures typical for cardiac surgery.

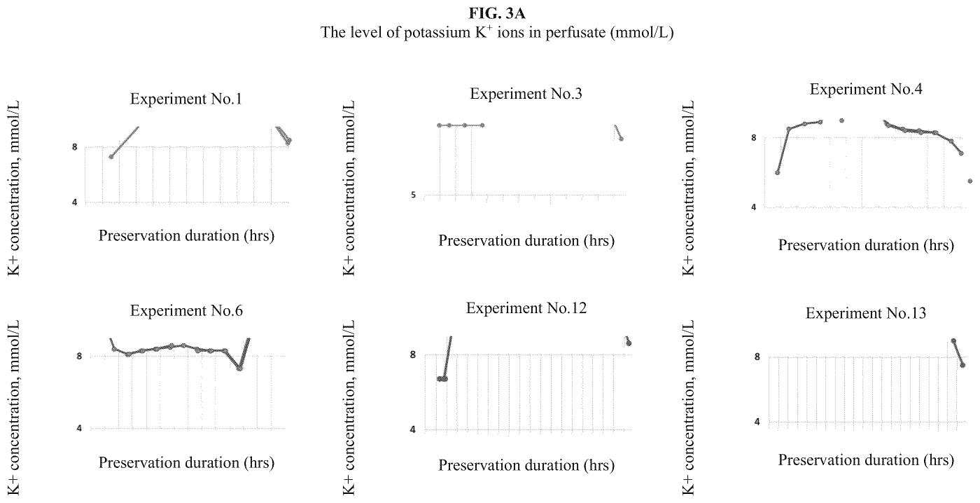

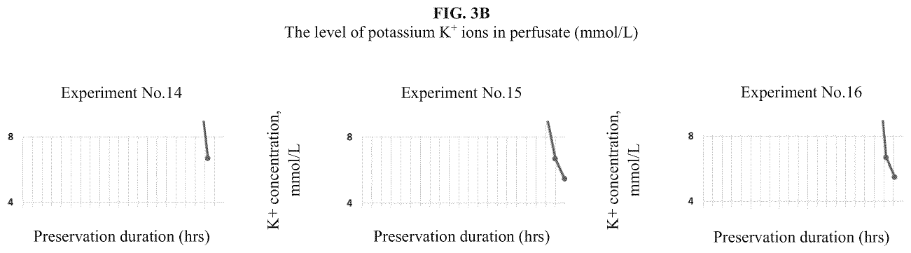

The potassium concentration in perfusate is maintained at a level higher than 9 mmol/L for the entire organ preservation period to ensure that the heart is maintained predominantly in a non-beating state. Experimental results have demonstrated that, as a rule, the heart begins to beat immediately after the organ is connected to the device perfusion start, even though the initial potassium concentration in perfusate after potassium cardioplegia, during organ collection, is 6 to 9 mmol/L or higher (FIGS. 3A and 3B). If required, potassium is injected into the perfusate. Moreover, during the process of heart preservation, with a constant potassium concentration in the perfusate higher than 9 mmol/L, the heart can start beating in the full extent or in bradycardia mode, especially after the introduction of glucose as part of measures to maintain biochemical composition in normal range of parameters. In this case, an additional dose of cardioplegic solution is injected into the perfusate.

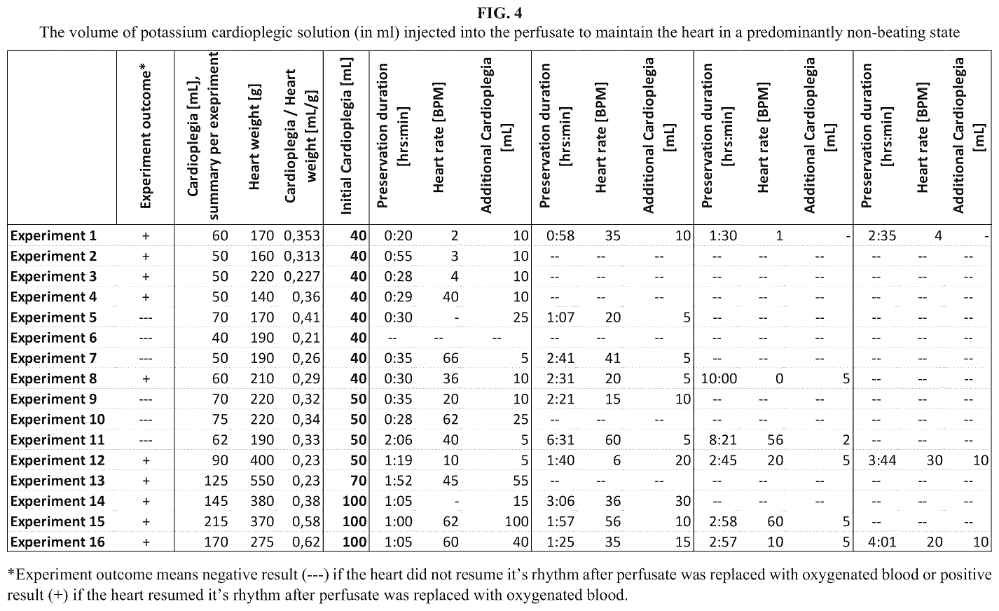

Initially, potassium cardioplegia in a mixture with the donor's blood in a ratio of 1:2 was injected into the aortic root to stop the heart inside the donor's body. The volume of the administered cardioplegic solution ranged from 40 ml to 100 ml, depending on the mass of the animal's weight (FIG. 4). In 16 experiments, except for experiment 6, the heart restored its contractility almost immediately when perfusion was started. In order to stop the heart again, additional doses of cardioplegic solution ranging from 5 ml to 100 ml were injected into the perfusate supply line. The period from the moment the aorta was cross-clamped to the beginning of perfusion, and, accordingly, to the introduction of an additional dose of cardioplegia, ranged from 20 minutes to 2 hours. Such a large spread is associated with technical difficulties that arose while connecting the heart vessels to the perfusion device lines. The need for subsequent doses of cardioplegia was determined by the emergence of ventricular activity. There are no patterns of recovery of contractility from the received dose of potassium solution or other indicators. Throughout 16 experiments, no additional dose of potassium cardioplegia was required in experiment 6, one dose (immediately after the start of perfusion)—in 5 experiments (2, 3, 4, 10, 13), two doses—in 5 experiments (1, 5, 7, 9, 14), three doses—in 5 experiments (8, 11, 12, 15, 16). The total volume of cardioplegic solution administered in experiments varies from 40 ml to 215 ml, including cardioplegic solution administered to arrest the heart in the donor's body. The same parameter corrected by a heart weight is less variable and lies in the range from 0.21 ml/g to 0.62 ml/g. With a conditional norm of 0.40 ml/g, the deviations of the indicator were up to 1.5 times. It shall be noted that the volume of potassium-containing cardioplegia depends on the type of cardioplegic solution and the individual characteristics of the organ.

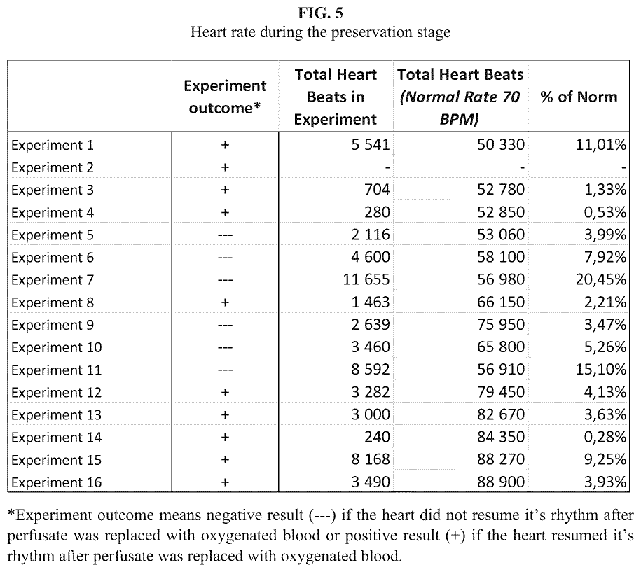

Preferred embodiments of the invention assume that the heart is kept in a predominantly non-beating state during the preservation period. However, the heart may restore its normal contractility or enter bradycardia immediately after starting perfusion or further during the process of preservation (FIG. 5). Thus, part of the time, the organ can be maintained in a beating state. As follows from the experiments, the total number of contractions during the preservation period varied from zero (pin experiment 2) to 20% of the norm (in experiment 7). The norm is calculated as the preservation period duration expressed in minutes multiplied by 70 (the normal heart rate). The inventors of the present application deem that it appears possible to increase this indicator up to one-third of the norm without compromising the quality of preservation, especially if the heart contracts in deep bradycardia mode. There is no relationship between the amount of total cardioplegic solution administered and the number of contractions during the preservation period.

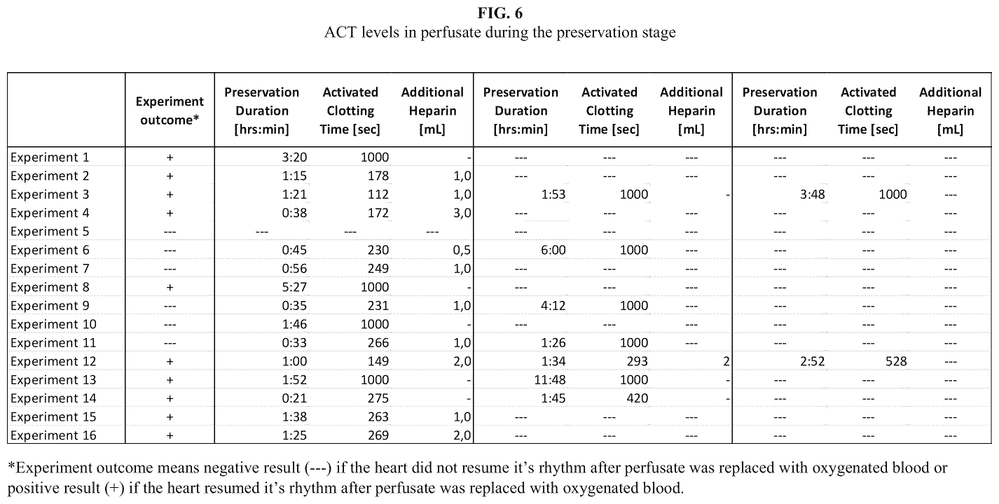

ACT is maintained at a high level for at least 400 seconds; if necessary, it is corrected by introducing heparin (or another pharmaceutical agent) into the perfusate, the same as during normal cardiac surgery. In a set of 16 experiments, additional administration of heparin was required in 10 out of 16 experiments during the first 2 hours after the aorta was cross-clamped in the donor's body (FIG. 6). Heparin was administered if the ACT was less than 400 seconds. The dose of heparin varied from 0.5 ml to 3 ml. A single case of a second additional injection of 2 ml of heparin was recorded in experiment 12. When perfusate heparinization is analyzed, one shall take into account that the donor's own blood, which is the base of perfusate, was already heparinized to a high extent at the stage of organ harvesting.

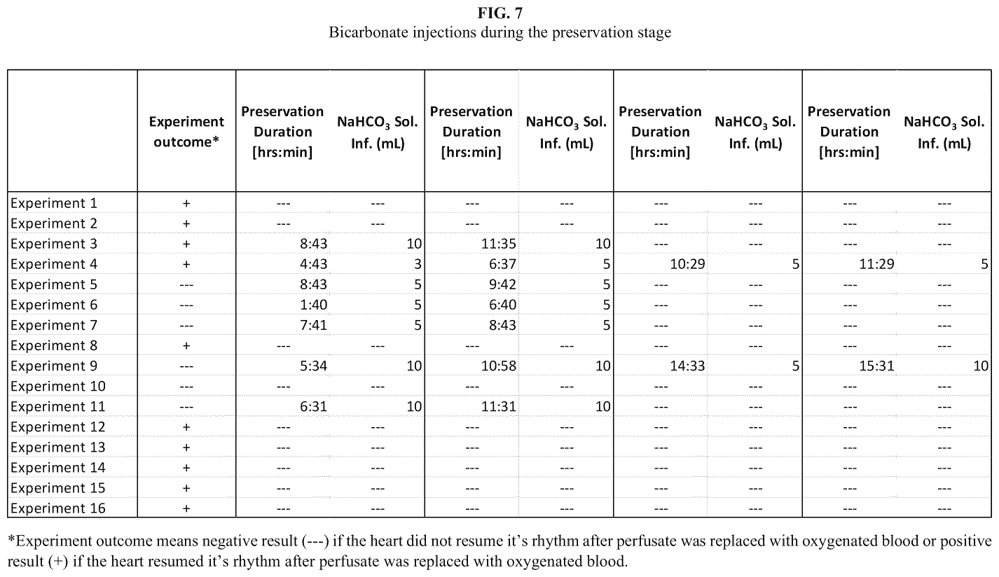

The most important indicator of the quality of the preservation process is the level of lactate in the perfusate. It is known that lactate level increases if there is a lack of oxygen in cells or when cellular energy production is disrupted. It is also known that the accumulation of lactate usually lowers the pH of the blood, provoking the occurrence of metabolic acidosis (violation of acid-base balance). The following correlation was observed in a set of 16 experiments with porcine hearts: in experiments with an upward lactate trend (experiments 3 to 7, 9, and 11), acidosis was recorded and had to be corrected with the introduction of NaHCO₃ (FIG. 7). Acidosis was not recorded, and such correction was not required in other experiments. Moreover, in experiments with stable lactate trend (experiments 2 and 12 to 16), acidosis was not recorded, and NaHCO₃ introduction was not required, even in experiment No. 2 when the weighted average lactate level was high, up to 7 mmol/L.

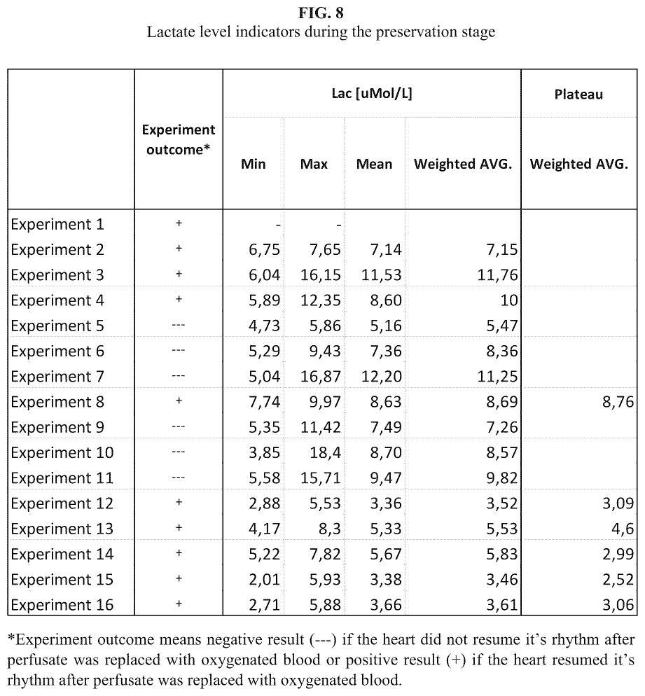

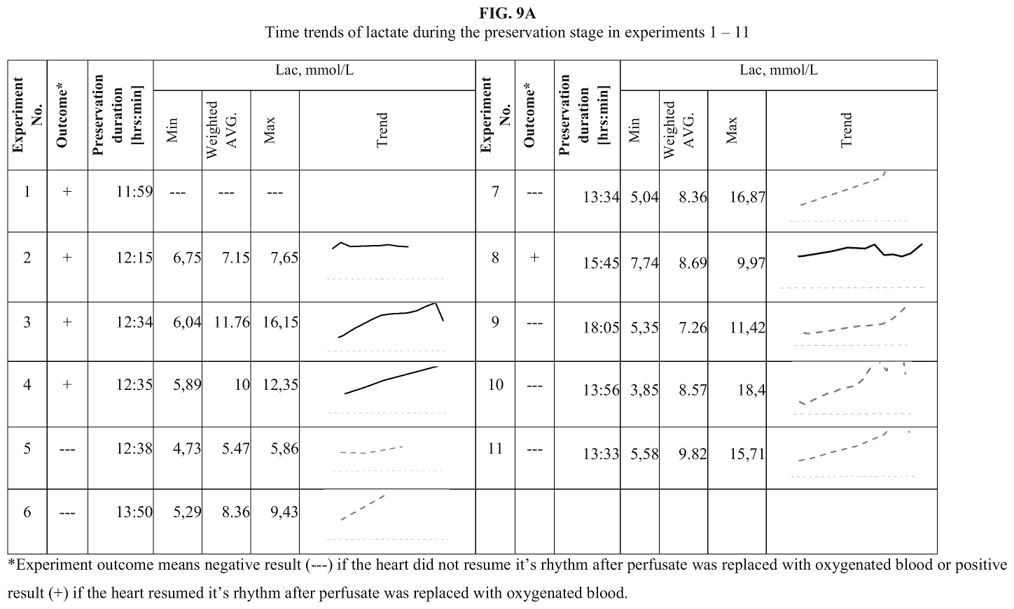

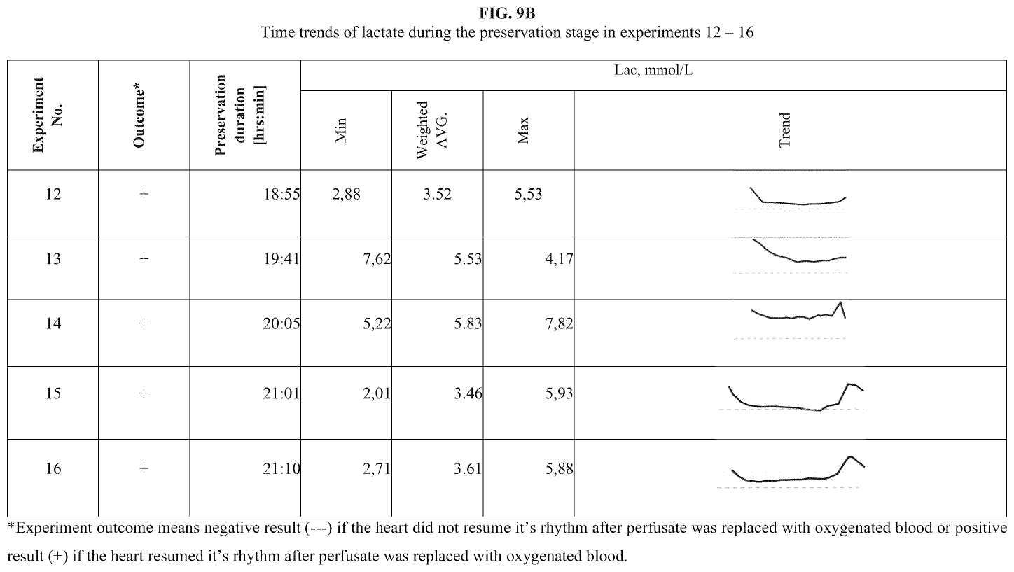

A set of 16 experiments on porcine hearts showed that the lactate level depends on the quality of perfusate oxygenation (FIG. 8 and FIGS. 9A and 9B) during the preservation process. It depends on the quality of oxygenation and not on the gas composition of the perfusate. In all these experiments, the gas composition, at least the partial pressure of oxygen and carbon dioxide, and O₂ saturation were constantly monitored and maintained within normal limits, but major differences in lactate level were observed. In experiments 1 to 11, technical difficulties with the quality of oxygenation occurred. As a result, an upward trend of lactate over time was recorded in almost every experiment (with both successful and unsuccessful outcomes of organ preservation), except for experiment 2, when a stable lactate trend was recorded (with a weighted average lactate value of 7.2 mmol/l). As a result, 6 out of 11 outcomes (in experiments 5 to 7 and 9 to 11) were negative, which means that the heart failed to restore its contractility. However, the weighted average lactate values in all 11 experiments varied from 7 mmol/L to 10 mmol/L.

It can be stated that the likelihood of death of perfused heart does not significantly depend on the level of lactate itself, but an upward time trend of lactate level increases the likelihood of organ death significantly. In a subset of 11 experiments, perfusion lasted from 12 to 18 hours, and the outcome (organ death or contractility restoration) did not correlate with the preservation duration. The outcomes (successful preservation of five hearts and death of six hearts) of these 11 experiments are mainly due to the quality of perfusate oxygenation and, and probably to a lesser extent, individual characteristics of the organs.

A subset of five later experiments (from 12 to 16) were performed with acceptable quality of perfusate oxygenation. All these experiments were completed successfully, i.e., the organ was preserved and resumed its normal contractility after replacing the circulating perfusate with a stored portion with normal potassium levels. The period of organ preservation in these experiments lasted from 19 to 21 hours, depending on the experimental plan. The condition of the preserved organs in these experiments allows one to assume that the preservation period in this invention can be extended further. Lactate time trends in experiments 12-16 are common, i.e., a lowering trend at the initial stage with a stable one for the rest of the experiment. The lowering trend at the initial stage is explained by a reduction of the lactate, which was accumulated during the period of ischemia from organ collection until the start of perfusion. The increasing trend at the end of the preservation stage in experiments 14, 15, and 16 is due to a scheduled perfusion pause, performed twice in each experiment: the first one lasted 10 minutes to model a 10-minute ischemia to check the preservation of the organ and the second one lasted 30 minutes to model 30 minutes of ischemia during the transfer of the organ from the device to the recipient's body with subsequent restoration of contractility. In experiments from 12 to 16, the weighted average lactate values varied from 2.5 mmol/L to 4.6 mmol/L in the stable area of the lactate time trend. Experiments 12-16 convincingly demonstrate that high quality of perfusate oxygenation allows one to achieve a downward-stable time trend of lactate concentration and to reduce lactate levels at times. Moreover, the duration of the preservation period of the organ has been increased by almost 2 times as compared to the first experiment, and, apparently, this is not the limit.

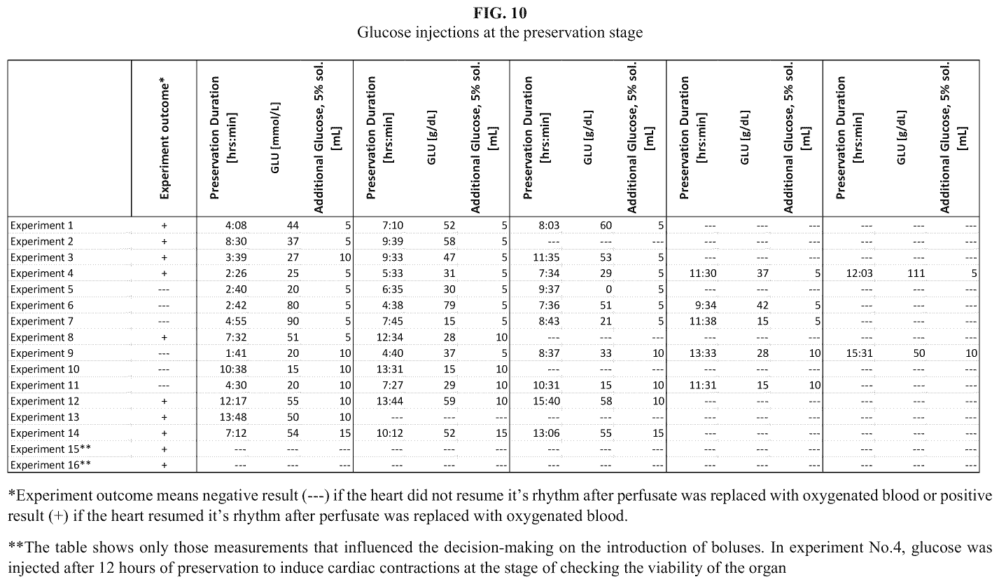

Glucose concentration in the perfusate decreases due to the energy expenditure of the organ during the preservation process. In experiments from 1 to 14, at least one dose of glucose was required. In experiments 15 and 16, glucose was not added during the entire preservation period of 21 hours. Results shown in FIG. 10 illustrate that in experiments characterized by a relatively stable time trend of lactate (No. 2 and from 12 to 16), glucose was consumed sparingly and additional doses were required a minimum number of times or additional doses were not required at all (experiments 15, 16). By contrast, in experiments characterized by a rising lactate trend, one can see active glucose consumption and regular re-administration 3 to 5 times per experiment. The recorded relationship between the time trend of lactate and glucose consumption is explained by the well-known fact that an increase in lactate levels is associated with a violation of cellular energy production, which depends on the quality of perfusate oxygenation, which lacked quality in experiments 1-11.

Conventional scale of glucose concentration levels is considered to be the following: low concentration is 20-70 mg/dL, normal concentration is 71-120 mg/dL, borderline concentration is 121-180 mg/dL, high concentration is 181-250 mg/dL and dangerous concentration above 251 mg/dL. In experiments on pigs and minipigs the initial glucose concentration varied from low to high, and during the preservation period, the concentration became low. As glucose was consumed, an additional dose was administered to increase glucose levels to normal values. As shown on FIG. 10, additional glucose was administered in experiments 4, 6 and 7 when glucose levels were normal. In experiment 4, at the end of the preservation period, when glucose level was 111 mg/dL, glucose was administered to activate the heartbeat and check the quality of contractility preservation. In experiments 6 and 7, significant glucose intake was recorded, and additional glucose injections were performed while glucose levels were still normal (from 80 to 90 mg/dL). It is important to note the connection between the above and poor quality of oxygenation in experiments 6 and 7.

In a subset of experiments from 1 to 11 (with technical problems of oxygenation), the weighted average perfusion pressure did not differ between successful (from 1 to 4 and 8) and unsuccessful experiments (from 5 to 7 and from 9 to 11)—and varied from 77 mm Hg to 99 mm Hg.

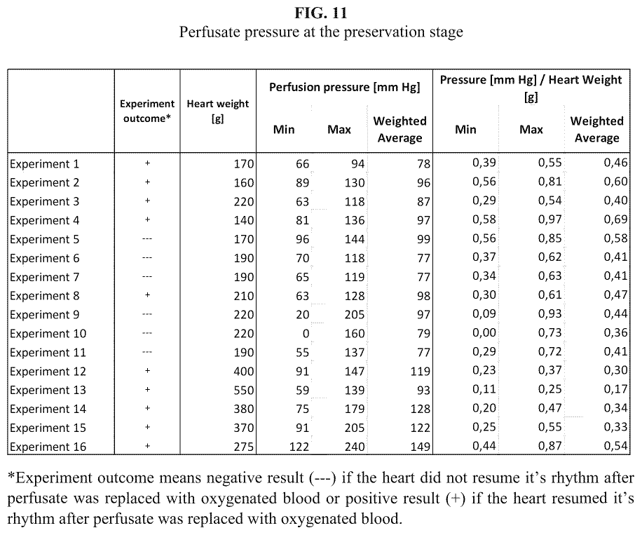

In a series of experiments from 12 to 16 (with acceptable oxygenation), the weighted average perfusion pressure was higher than in experiments 1-11, and varied from 93 mm Hg to 149 mm Hg. This difference is explained by the fact that the mass of the preserved organs in the subset of later experiments was almost 2 times higher than in experiments from 1 to 11. The ratio of perfusion pressure to the mass of the organ experiments varies from 0.17 mmHg/g to 0.69 mmHg/g, being slightly higher in a subset of experiments 1 to 11 (with low heart masses) than in subset of experiments 12-16 (FIG. 11). Conditional norm of diastolic pressure is 0.35 mmHg/g, with deviation of up to two times in both directions. On major scale, throughout experiments, the perfusion pressure was maintained closer to the level of normal diastolic pressure while the mass of the preserved organ was taken into account. In the subset of experiments 1-11 (with low heart masses), the weighted average pressure value was slightly less than 100 mm Hg, while in the subset of experiments 12-16 (with high organ masses), the weighted average pressure value was closer to 120 mm Hg.

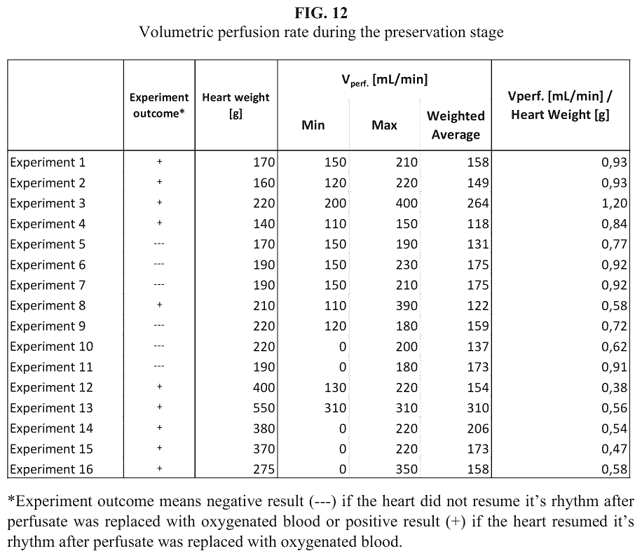

The conditional norm of coronary blood flow volume rate corrected to heart masses in a non-beating state of the preserved heart is considered to be 0.60 ml/min/g. The weighted average value of this indicator in a subset of experiments with an increasing lactate trend (1-7, 9-11) varied from 0.62 ml/min/g to 1.20 ml/min/g. The same indicator in a subset of experiments with a stable lactate trend (8, 12-16) varied from 0.38 ml/min/g to 0.58 ml/min/g (FIG. 12). Thus, the perfusion volume rate corrected for hearts masses for experiments with a stable lactate trend a high organ mass was two times lower than conditional norm, and the perfusion volume rate corrected to heart masses for experiments with an upward lactate trend were up to two times higher than conditional norm. However, absolute perfused volume rate values were higher in successful experiments than in unsuccessful ones. In a series of experiments 12-16 (with acceptable oxygenation), the weighted average perfusion volume rate ranged from 154 ml/min to 310 ml/min, while in experiments 1-11—from 118 ml/min to 264 ml/min.

The higher perfusion volume rate in experiments 12-16 compared to experiments 1-11 is explained by the fact that the mass of the preserved organ in the last experiments was almost 2 times higher. In general, the perfusion volume rate throughout the experiments was maintained closer to the level of the normal volume rate of blood passing through the coronary network in natural conditions, but taking into account the mass of the preserved organ. The choice of perfusion volume rate is determined by the required parameters of perfusion pressure, which should be within the limits that are close to the normal diastolic value, taking into account the mass of the organ.

The foregoing demonstrates a donor heart can be preserved for a duration of up to at least 20 hours, or even longer, under the conditions of normothermal blood perfusion, provided that the heart is kept in a predominantly non-beating state while acid-base state parameters, concentrations of gases, concentration of electrolytes and metabolic products are kept within normal limits by conventional intensive care measures typical of cardiac surgery.

Coronary blood flow volume (perfusion volume rate) and perfusate pressure are also maintained within normal limits. The potassium concentration in the perfusate is maintained at a level higher than 9 mmol/L to prove the heart to stay in a non-beating state. The ACT (Activated Clotting Time) shall be at least 400 sec. The key indicator of the quality of organ preservation is the lactate level and its time trend. Successful long-term preservation of a donor's heart is possible with a stable lactate trend, preferably at a concentration level close to normal. A stable lactate trend at concentrations of up to 5-6 mmol/L allows preservation of the heart with high quality for up to 20 hours or even longer or up to 12 hours with lactate concentration levels above 6 mmol/L.

Implementing high-quality perfusate oxygenation enables the possibility to keep lactate stable, at the normal level or close to the norm, and allows preservation of the organ for 24 hours or even more with high quality.

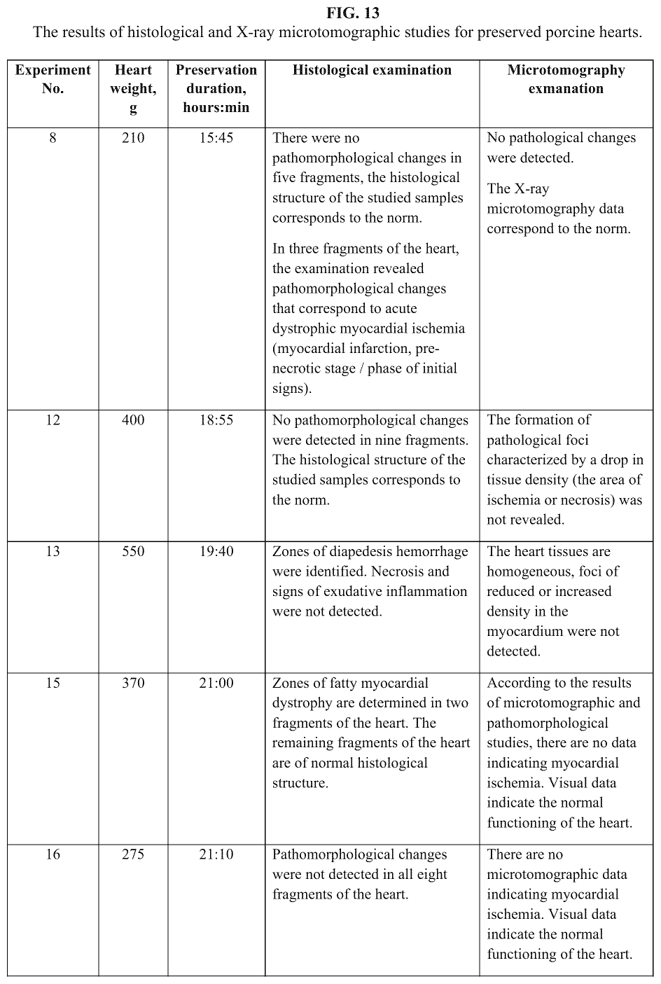

The donor organs preserved in experiments 8, 12, 13, 15, and 16 were subjected to histological and microtomographic examination. The results are shown in FIG. 13.

Histological examination. The stained tissue sections were covered with cover glasses in the apparatus to expose samples. Sub-X Mounting Medium, Leica was used as the exposure environment. Exposed histological samples were kept until the medium solidified and were subsequently subjected to histological analysis. Light microscopy was performed using a Leica DM2000 microscope. Sliced sections were photographed with a microscope camera in a standard operating mode of the device, through a 20× or 40× lens for magnification of ×200 or ×400, respectively, at the pathologist's discretion.

Microtomographic examination. Sections of the heart were fixed in buffered formalin; dehydration was performed in ascending concentrations of ethyl alcohol (50, 70, 80, 90, 96%). After that, dehydrated samples were exposed for 24 hours to a 1% iodine solution in alcohol. The samples were placed in containers and filled with 96% alcohol for subsequent scanning. The samples were examined using a Bruker SkyScan 1276 X-ray microtomograph; the tube voltage was 90 kV, the current was 200 microamps, and an aluminum-copper filter with a thickness of 1 mm was also installed. The resulting projections were transformed into a sequence of slices for further analysis using Bruker NRecon software. The analysis of tomograms was performed in the 3D Slicer software package.

Histological and microtomographic examination data indicate a high quality of donor organs that were preserved for 16 to 21 hours, according to embodiments of the invention. In the organ after experiment 8, histological examination revealed the emergence of initial signs of myocardial infarction in separate fragments, even though the preservation of the organ lasted for 15 hours 45 minutes (minimal time for examined hearts). This is explained by the fact that during the preservation process, an upward trend of lactate with a weighted average level of 8.76 mmol/L was observed. Further preservation of this organ would inevitably lead to its demise.

On the contrary, the hearts from experiments 12, 13, 15, and 16, that were preserved for 19 to 21 hours, did not contain histological and microtomographic signs of ischemia. In each of these experiments, a downward-stable lactate trend was observed. Moreover, in experiments 14, 15, and 16, organs were subjected to consecutive 10-minute and 30-minute ischemia, followed by the resumption of normal contractility (simulation of organ disconnection from the device transplantation into the recipient's body).

Based on the results of in vitro experiments, which are described further in the examples, a potassium cardioplegic solution was selected, which was mainly used to stop and protect the heart when it was taken from a donor, as well as to maintain the heart in a non-beating state during its preservation at perfusion modes according to the present invention. A potassium cardioplegic solution of the following composition was used:
Potassium chloride—7.45 g;
Magnesium sulfate—2.34 g;
Trometamol—0.5 g;
Mannitol—35.9 g
Distilled water—up to 1000 ml, provided by introduction of 1M hydrochloric acid until pH is 7.6-8.0.

The examples presented below (Tables 1 to 3) illustrate, but do not limit, the present invention. Comparative studies were carried out on the cells of cardiomyocytes of the ventricles of the heart of newborn rats.

Rat ventricular myocytes (RVMs) were obtained from Wistar rats aged 1 or 2 days old. Cultivation was carried out on plastic plates coated with collagen in a nutrient medium containing 15% fetal bovine serum (FBS). The next day, the nutrient medium was replaced with a non-serum one. During 1-2 days of cultivation, a merged monolayer of spontaneously contracting RVMs was formed in the wells.

The survival rate of cardiomyocytes was compared at normal temperature in the control group and after the addition of 10% of a proposed cardioplegic solution to the nutrient solution to preserve the donor heart (which led to a stop of myocyte contractions) and also in HTK Solution group, where the culture was cooled to 4° C. and placed in a solution of Custodiol® (which also led to a stop of myocyte contractions). To assess the survival of myocytes, a methyl tetrazolium test (MTT) and a flow cytometry method test were performed to register apoptotic cells.

The methyltetrazolium test (MTT) photometrically measures the total activity of mitochondrial dehydrogenases of cells in each well. This test is based on the ability of living metabolically active cells to convert tetrazolium salt (MTS) into formazan, which is soluble in the cell culturing medium. Thus, the absorption of formazan is directly proportional to the number of viable cells in the culture.

A set of CellTiter 96® AQueous One Solution Cell Proliferation Assay (MTS), Promega is used for MTT (methyltetrazolium test). Cells are incubated with MTS for 30-40 minutes in a thermostat to measure the absorption of formazan. The measurement of the absorption of formazan was carried out at 2=492 nm with Awareness Microplate Rider Stat Fax 3200 enzyme immunoassay device.

The cytotoxic effect of the studied solutions was evaluated as the percentage of cell death in the well compared to the control, the value of which is calculated from the values of the optical density of solutions in the wells:
% of death=100−ODₑ/OD_{c}*100, where ODₑ is an experimental indicator of the average optical density, and OD is the optical density in control wells.

For cytofluorimetric analysis, cell samples must be lysed, washed with a phosphate-salt buffer (FSB) twice, and then fixed in 70% ethanol to be cooled and stored at −200° C. until an analysis procedure. The cells that are fixed in ethanol must washed with FSB, treated with a solution of RNA-aza (150 U/ml), and stained with a solution of propidium iodide (PI) (“Sigma Aldrich”) at a concentration of 50 micrograms/ml for 30 minutes at room temperature.

The samples obtained in the laboratory were studied on the Cytomics FC 500 device (Becton Coulter, USA). An argon laser (wavelength 488 nm, 1000 W) was used to excite fluorescence. The measurements were carried out at a rate of up to 2,000 cells per second. At least 30,000 cell nuclei were analyzed in each sample. Cells were differentiated by DNA content—diploid (2n2c), tetraploid (2n4c), and hypodiploid (apoptotic) (less than 2p2c) using special software. The analysis of the distribution of cells on the DNA histogram by phases of the cell cycle was carried out according to the Cell FIT software. The percentage of apoptotic cells was calculated based on the measurement of hypodiploid DNA, that was stained with PI at a concentration of 50 μg/ml. Apoptotic cells with a DNA content of less than 2n2c were recorded.

TABLE 1
Basic examples of manufacturing solution composition variants

| Example No. | Composition |
|---|---|
| Example No. 1 | Potassium chloride - 7.45 g |
| | Magnesium sulfate - 2.34 g |
| | Trometamol - 0.5 g |
| | Hydrochloric acid 1M - 0.1 g |
| | Mannitol. g - 35.9 |
| | Distilled water - up to 1000 ml |
| Example No. 2 | Potassium chloride - 8.38 g |
| | Magnesium sulfate - 2.34 g |
| | Trometamol - 0.5 g |
| | Hydrochloric acid 1M - 0.1 g |
| | Mannitol - 35.9 g |
| | Distilled water - up to 1000 ml |
| Example No. 3 | Potassium chloride - 3.00 g (40.2 mmol/l) |
| | Distilled water - up to 1000 ml |
| Example No. 4 | Potassium chloride - 300.00 g (4021.4 mmol/1) |
| | Distilled water. ml - up to 1000 |
| Example No. 5 | Potassium chloride - 7.45 g |
| | Magnesium sulfate - 6.00 g (24.3 mmol/l) |
| | Distilled water - up to 1000 ml |
| Example No. 6 | Potassium chloride - 8.38 g |
| | Magnesium sulfate - 2.34 g |
| | Sodium acetate - 1.0 g |
| | Acetic acid 1M - 0.3 g |
| | Mannitol - 35.9 g |
| | Distilled water - up to 1000 ml |

TABLE 2
MTT test. Study of the survival rate of cardiomyocytes cell culture

| | 0 hours | 6 hours | 12 hours | 24 hours |
|---|---|---|---|---|
| Normal nutrient medium | 0 | −19.64 | −5.55 | −9.47 |
| Custodiol ® (HTK Solution) | 0 | 53.15 | 71.46 | 81.69 |
| Example No. 1 | 0 | −1.76 | −5.13 | 16.36 |
| Example No. 2 | 0 | −1.55 | −5.21 | 17.56 |
| Example No. 3 | 0 | −1.02 | −3.86 | 19.87 |
| Example No. 4 | 0 | −0.16 | −1.25 | 32.89 |
| Example No. 5 | 0 | −2.36 | −5.84 | 18.21 |
| Example No. 6 | 0 | −1.95 | −4.84 | 17.87 |

*negative values indicate that the metabolic activity of cells has increased compared to the control value.

TABLE 3
Flow cytometry method. Study of the survival rate of cardiomyocytes
cell culture, %

| | 0 hours | 6 hours | 12 hours | 24 hours |
|---|---|---|---|---|
| Normal nutrient medium | 3.49 | 4.92 | 4.77 | 3.91 |
| Custodiol ® (HTK Solution) | 3.49 | 7.47 | 35.8 | 74.26 |
| Example No. 1 | 3.49 | 4.93 | 4.03 | 4.29 |
| Example No. 2 | 3.49 | 5.06 | 4.45 | 4.31 |
| Example No. 3 | 3.49 | 5.79 | 4.74 | 5.68 |
| Example No. 4 | 3.49 | 7.96 | 6.98 | 8.65 |
| Example No. 5 | 3.49 | 5.64 | 4.36 | 5.73 |
| Example No. 6 | 3.49 | 4.48 | 4.65 | 4.02 |

The results of the experiment with cardiomyocyte cell culture demonstrate that the best survival rate was achieved in the control group, followed by the survival rate of cardiomyocytes exposed to different variations of the normothermic cardioplegic solution to preserve them for 24 hours. The lowest survival rate was achieved in the group of cardiomyocyte cell cultures exposed to the hypothermic cardioplegic solution Custodiol®, which is known to be indicated for organ preservation.

After 24 hours after exposure to cardioplegic solutions, cell death rate in the Custodiol® group was almost 75%, while in different examples of normothermic cardioplegic solutions, the death rate varied from 4% to 9%, compared to a 4% death rate in the control group. Thus, a dramatic advantage of the proposed solution over the hypothermic cardioplegic solution Custodiol® is demonstrated for cell preservation.

The results of the experiments demonstrate that both for the MTT test and for the Flow cytometry test, the best survival rate is achieved in the nutrient medium control group. If a normothermic cardioplegic solution is added in different compositions, the cardiomyocyte survival rate is slightly lower than in the nutrient medium control group. After 24 hours, the cell population remains viable. However, if Custodiol® (HTK solution) is added to the medium and the medium is cooled, then almost 80% of the cells in the culture die within 24 hours of preservation. The results of the experiment show a significant advantage of the proposed solution for cell preservation over the hypothermic cardioplegic Custodiol® solution.

Taking into account the similarity of results for proposed solution examples and the composition of Example 3, one can see that the only two mandatory components of the cardioplegic solution proposed to preserve the vital activity are potassium ions in concentration (volume) required and sufficient to stop and maintain the donor heart in a (predominantly) non-beating state and distilled water. All other components of the proposed cardioplegic solution are important to provide the vital activity of the isolated heart. However, under certain conditions, they may be excluded from the composition of the cardioplegic solution.

The best results in the described tests were achieved by the composition of Example No. 1 (Tables 2 and 3), so additional studies were performed to examine if its components may be replaced to achieve even better results (Tables 4-6).

TABLE 4
Examples of detailed options for manufacturing proposed
cardioplegic solution.

| Example No. | Composition |
|---|---|
| Example No. 7 | Potassium chloride, g - 7.45 |
| | Magnesium sulfate, g - 2.34 |
| | Trometamol, g - 0.5 |
| | Mannitol, g - 35.9 |
| | Hydrochloric acid 1M g - 0.1 |
| | Distilled water, ml - up to 1000 |
| Example No. 8 | Potassium chloride, g - 7.45 |
| | Magnesium sulfate, g - 2.34 |
| | Trometamol, g - 0.5 |
| | Mannitol, g - 35.9 |
| | Sulfuric acid 1 Mg - 0.1 |
| | Distilled water, ml - up to 1000 |
| Example No. 9 | Potassium chloride, g - 7.45 |
| | Magnesium sulfate, g - 2.34 |
| | Trometamol, g - 0.5 |
| | Mannitol, g - 35.9 |
| | Citric acid 1 Mg - 0.3 |
| | Distilled water, ml - up to 1000 |
| Example No. 10 | Potassium chloride, g - 7.45 |
| | Magnesium sulfate, g - 2.34 |
| | Bicarbonate g - 1.0 |
| | Mannitol, g - 35.9 |
| | Hydrochloric acid 1M g - 0.1 |
| | Distilled water, ml - up to 1000 |
| Example No. 11 | Potassium chloride, g - 7.45 |
| | Magnesium sulfate, g - 2.34 |
| | Bicarbonate g - 1.0 |
| | Mannitol, g - 35.9 |
| | Sulfuric acid 1 Mg - 0.1 |
| | Distilled water, ml - up to 1000 |
| Example No. 12 | Potassium chloride, g - 7.45 |
| | Magnesium sulfate, g - 2.34 |
| | Bicarbonate g - 1.0 |
| | Mannitol, g - 35.9 |
| | Citric acid 1 Mg - 0.3 |
| | Distilled water, ml - up to 1000 |
| Example No. 13 | Potassium chloride, g - 7.45 |
| | Magnesium sulfate, g - 2.34 |
| | Trometamol, g - 0.5 |
| | Mannitol, g - 35.9 |
| | Dextrose, g - 60.0 |
| | Distilled water, ml - up to 1000 |
| Example No. 14 | Potassium chloride, g - 7.45 |
| | Magnesium sulfate, g - 2.34 |
| | Bicarbonate g - 1.0 |
| | Mannitol, g - 35.9 |
| | Dextrose, g - 60.0 |
| | Distilled water, ml - up to 1000 |

TABLE 5
MTT test. Study of the survival rate of cardiomyocyte cell culture, %

| | 0 hours | 6 hours | 12 hours | 24 hours |
|---|---|---|---|---|
| Example No. 7 | 0 | −1.81 | −5.02 | 16.44 |
| Example No. 8 | 0 | −1.57 | −4.39 | 17.58 |
| Example No. 9 | 0 | −1.63 | −4.49 | 16.14 |
| Example No. 10 | 0 | −1.97 | −4.85 | 17.68 |
| Example No. 11 | 0 | −1.57 | −5.42 | 16.14 |
| Example No. 12 | 0 | −1.76 | −5.33 | 16.86 |
| Example No. 13 | 0 | −1.66 | −5.06 | 16.94 |
| Example No. 14 | 0 | −1.98 | −5.74 | 15.98 |

*negative values indicate that the metabolic activity of cells has increased compared to thecontrol indicator.

TABLE 6
Flow cytometry method. Study of the survival rate of cardiomyocyte
cell culture, %

| | 0 hours | 6 hours | 12 hours | 24 hours |
|---|---|---|---|---|
| Example No. 7 | 3.55 | 4.98 | 4.14 | 4.33 |
| Example No. 8 | 3.55 | 5.36 | 4.85 | 4.71 |
| Example No. 9 | 3.55 | 5.59 | 4.74 | 4.86 |
| Example No. 10 | 3.55 | 5.27 | 4.65 | 4.18 |
| Example No. 11 | 3.55 | 5.84 | 4.26 | 5.31 |
| Example No. 12 | 3.55 | 4.79 | 4.95 | 4.14 |
| Example No. 13 | 3.55 | 4.23 | 4.09 | 4.69 |
| Example No. 14 | 3.55 | 5.54 | 3.75 | 4.94 |

The results of the experiment have demonstrated that the replacement of individual components of the proposed solution with other pharmaceutically acceptable components insignificantly affects the survival of cardiomyocyte cells.

What claimed is:

1. A method of preserving a donor heart, comprising perfusing the donor heart with oxygenated blood-based perfusate, wherein the donor heart is predominantly kept in non-beating state.

2. The method according to claim 1, wherein the donor heart is initially placed in the non-beating state by administration of potassium cardioplegia; wherein the donor heart is then subsequently received for preservation in the non-beating state.

3. The method according to claim 1, wherein the blood-based perfusate comprises blood donated by the individual providing the donor heart.

4. The method according to claim 1, wherein the preserved donor heart is perfused at a temperature of 20-37° C.

5. The method according to claim 1, wherein during a stage of heart preservation, oxygenated perfusate is fed into the aorta and enters the mouths of coronary arteries, and subsequently oxygen-depleted perfusate leaves coronary vessels through coronary sinus, right atrium, right ventricle, and is finally taken into the perfusion system through the superior vena cava or pulmonary artery for repeated oxygenation.

6. The method according to claim 1, wherein during the stage of preservation, the potassium ions concentration in perfusate is maintained at the level of at least 9 mmol/L.

7. The method according to claim 1, wherein during the stage of preservation, if the heart begins to contract fully or enters bradycardia, an additional administration of potassium ions is added into the perfusate to transfer the heart to a non-beating state.

8. The method according to claim 1, wherein during the stage of preservation, the heart does not beat or beats periodically or beats in bradycardia mode, wherein the total number of contractions during the entire preservation period does not exceed one-third of the normal number of contractions for the same period, calculated based on a conditional physiological norm of 70 contractions per minute multiplied by the duration of preservation period expressed in minutes.

9. The method according to claim 1, wherein during the stage of organ preservation, blood clotting ability is monitored, and if the values of Activated Clotting Time (ACT) are less than 400 seconds, ACT is adjusted by adding heparin into perfusate.

10. The method according to claim 1, wherein during the stage of organ preservation, a stable or downward time trend of the lactate level is maintained.

11. The method according to claim 1, wherein during the stage of organ preservation, the glucose concentration in perfusate is maintained inside normal range.

12. The method according to claim 1, wherein during the stage of organ preservation, acid-base state, gas, and biochemical composition of the perfusate is maintained within the range of their normal values inside arterial and venous lines.

13. The method according to claim 1, in which the perfusion pressure divided by the mass of the heart is maintained in the range of 0.17-0.70 mmHg/g with a conditional norm of 0.35 mmHg/g.

14. The method according to claim 1, wherein the volumetric perfusion divided by the mass of the heart rate is maintained in the range of 0.3-1.2 ml/min/g with a conditional norm of 0.6 ml/min/g.

15. A device for preserving a donor heart according to the method of claim 1, comprising a container to store an organ, a container with perfusate, an oxygenator, a pump, a heat exchanger, and tube lines that connect all the elements into a single perfusion system, wherein the device is configured to provide perfusion of the organ with oxygenated perfusate.

16. The device according to claim 15, comprising a unit to monitor the perfusion volume rate, perfusate pressure, heart rate, acid-base state, gas, and biochemical compositions of the perfusate inside arterial and venous lines.

17. A device according to claim 15, comprising a unit to control the perfusion volume rate, perfusate pressure, heart rate, acid-base state, gas, and biochemical compositions of the perfusate, and a unit configured to inject electrolytes and medicines into the perfusate to bring the perfusate parameters to within a predefined range.

18. A cardioplegic solution for preserving a donor heart according to the method of claim 1, comprising potassium ions in an amount sufficient to stop the donor heart and to maintain it in a non-beating state, wherein said solution further comprises at least one of the components selected from the group consisting of magnesium ions, diuretic, base, acid, and distilled water.

19. The cardioplegic solution according to claim 18, wherein the solution is an aqueous solution containing:
potassium chloride 3-15 g;
a buffer system with a concentration of hydrogen ions H⁺, providing a pH of the solution in the range of 7.1-8.9; and
distilled water—up to 1000 ml.

20. The cardioplegic solution according to claim 18, wherein the solution is an aqueous solution containing:
potassium ions 3-15 g;
magnesium chloride 0-2.93 g;
a buffer system with a concentration of hydrogen ions H⁺, providing a pH of the solution in the range of 7.1-8.9; and
distilled water—up to 1000 ml.

21. The cardioplegic solution according to claim 18, wherein the solution is an aqueous solution containing:
potassium chloride 3-15 g;
magnesium sulfate 0-2.93 g;
a pharmaceutically acceptable diuretic providing osmolarity in the range of 275-460 mOsm/kg.;
a buffer system with a concentration of hydrogen ions H+, providing a pH of the solution in the range of 7.1-8.9; and
distilled water—up to 1000 ml.

22. The cardioplegic solution according to claim 18, wherein the solution is derived from the following components:
potassium chloride—7.45 g;
magnesium sulfate—2.34 g;
trometamol—0.5 g;
mannitol—35.9 g;
distilled water—up to 1000 ml; and
1M hydrochloric acid, wherein the hydrochloric acid is used to adjust the pH of the solution to 7.6-8.0.
